(19) United States
(12) Patent Application Publication
(10) Pub. No.: US 2003/0033923 A1
(43) Pub. Date: Feb. 20, 2003

(54) Guiding member of carpenter's saw table

(76) Inventor: Nick Chen, Taichung (TW)

Correspondence Address: BROWDY AND NEIMARK, P.L.L.C., 624 NINTH STREET, NW, SUITE 300, WASHINGTON, DC, 20001-5303, US

(21) Appl. No.: 09/930,238

(22) Filed: Aug. 16, 2001

(51) Int. Cl. B27B 21/02; B27G 5/02

(52) U.S. Cl. 83/767; 83/764; 83/581

(57) ABSTRACT

The present invention relates to a body of the guiding member of a carpenter's saw table. The long body is provided with a long guiding through hole and a long narrow slit extending along the longitudinal direction of the body and communicating at one end thereof with said through hole. The other end of the narrow slit is provided with a saw teeth receiving portion having a wider gap. The two long sides of the body are provided with a guiding fitting hole extending along the longitudinal direction of the body for use in fitting the guiding member on a pair of support rods of the saw table.

### FIELD OF THE INVENTION

The present invention relates generally to a carpenter's saw table, and more particularly to a guiding member of the carpenter's saw table.

### BACKGROUND OF THE INVENTION

As shown in FIG. 1, an angularly-adjustable carpenter's saw table of the prior art comprises a cantilever 11 which is provided thereon with two pairs of support rods 12 which are in turn provided with a guiding member 13 to cooperate with a special hacksaw 14 to enable the hacksaw 14 to move about between two pairs of support rods 12 so as to execute the sawing operation. In using the prior art carpenter's saw table, the guiding member must be matched with the hacksaw. However, most of American families are not provided with such a special hacksaw. What they have is a long sawing blade 20 as shown in FIG. 4. This kind of long sawing blade has a long blade body which is provided in one longitudinal side with a protective plate 21 for holding the long blade body to prevent the blade from bending or deforming. Other longitudinal side is provided with teeth 22. The long blade body is provided at one end with a hand grip 23. This kind of the long blade is not suitable for use in the adjustable saw table described above.

### SUMMARY OF THE INVENTION

The primary objective of the present invention is to provide an adjustable carpenter's saw table with a guiding member for mounting a long sawing blade on the adjustable saw table.

The foregoing objective is attained by the guiding member which is mounted on a pair of support rods of the adjustable saw table. The guiding member comprises a long body which is provided at one end with a long guiding through hole and a long narrow slit extending along the longitudinal direction of the body. The narrow slit communicates at one end thereof with said through hole and is provided with at the other end with a saw teeth receiving portion with a wider gap. The two long sides of the body are provided with a guiding fitting hole for fitting the guiding member on one pair of support rods of the adjustable saw table.

### BRIEF DESCRIPTION OF THE DRAWINGS

FIG. 1 shows a perspective view of a carpenter's saw table of the prior art.

FIG. 2 shows a side view of the present invention.

FIG. 3 shows a sectional view taken along a line 3-3 as shown in FIG. 2.

FIG. 4 shows a perspective view of the present invention and the long sawing blade and the carpenter's saw table before combination.

FIG. 5 shows a perspective view of the present invention and the long sawing blade and the carpenter's saw table after combination.

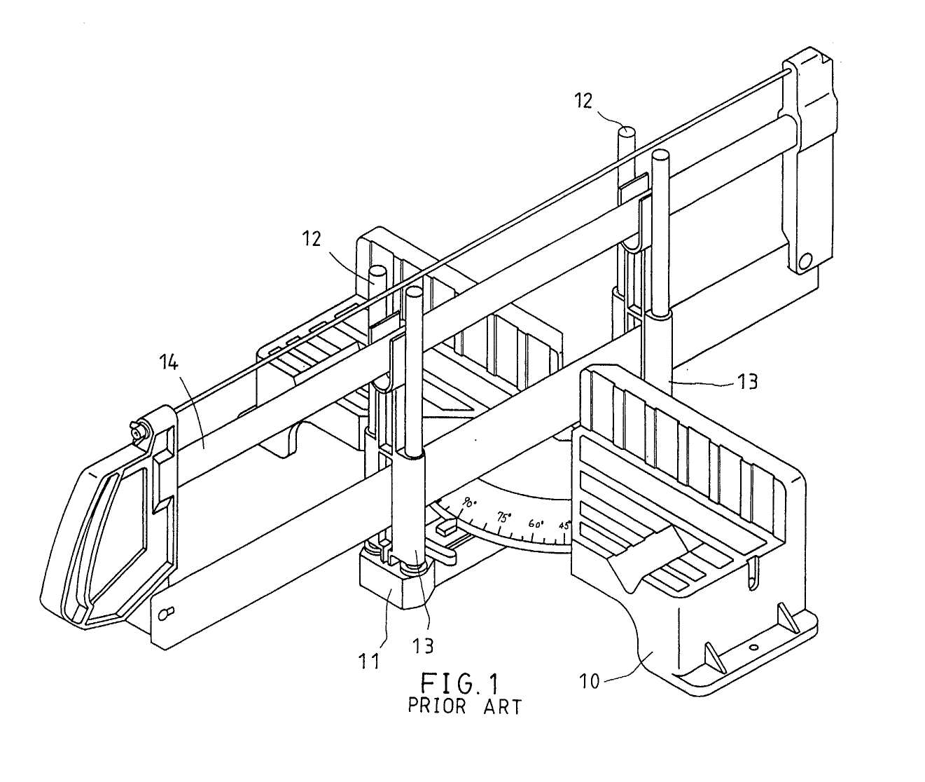

### DETAILED DESCRIPTION OF THE INVENTION

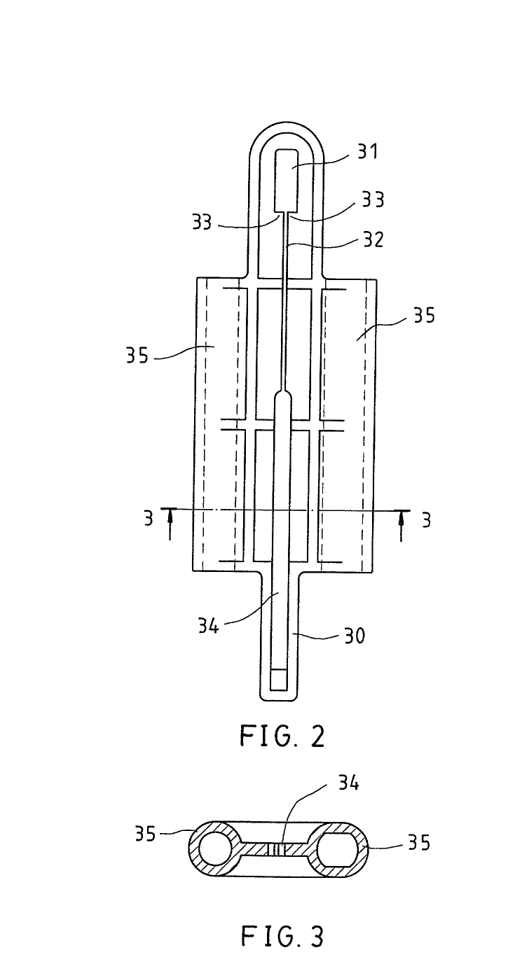

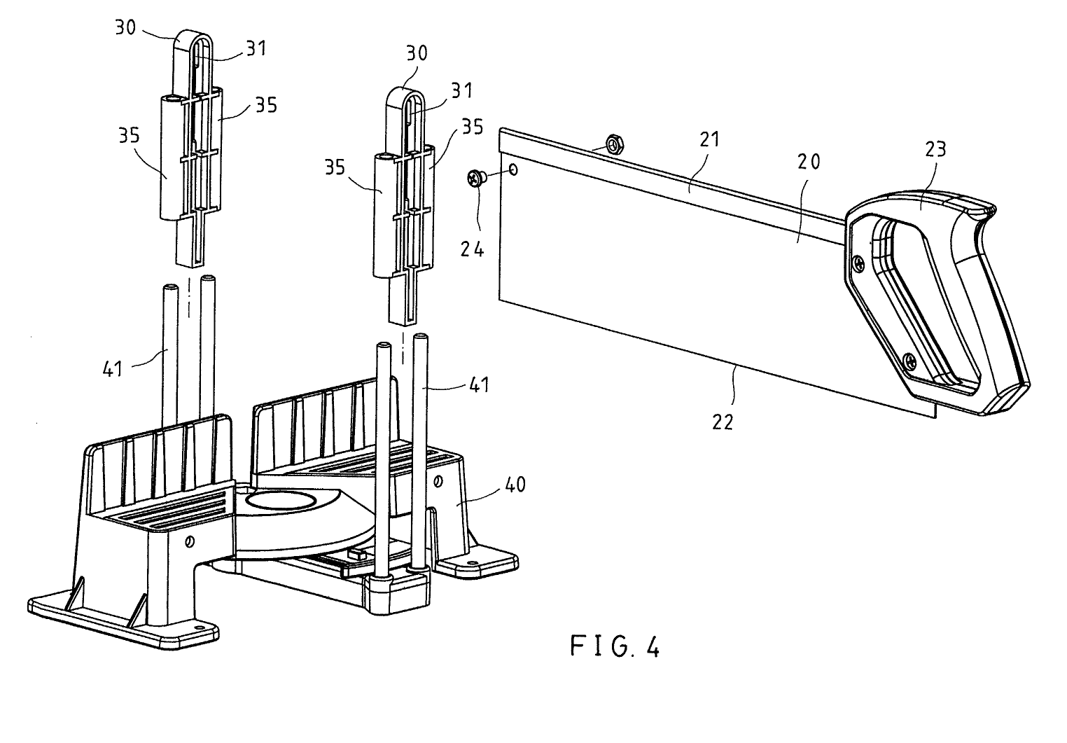

As shown in FIGS. 2-4, the guiding member of the carpenter's saw table of the present invention comprises the following components.

A long body 30 is provided at one end with a long guiding through hole 31 and a long narrow slit 32 extending along the longitudinal direction of the body and communicating with said through hold 31, thereby dividing the inner wall of the guiding through hole by the narrow slit into two shoulder faces 33. The narrow slit extends from the guiding through hole to the proximity of other end of the body, thereby forming in the rear segment thereof a saw teeth receiving portion 34 having a wider gap. The body 30 is provided in two long sides with a guiding fitting hole 35 extending along the longitudinal direction of the body for guiding the guiding member to fit on a pair of support rods 41 of the adjustable saw table 40. The body and the two guiding fitting hole of the embodiment of the present invention are integrally made of a plastic material.

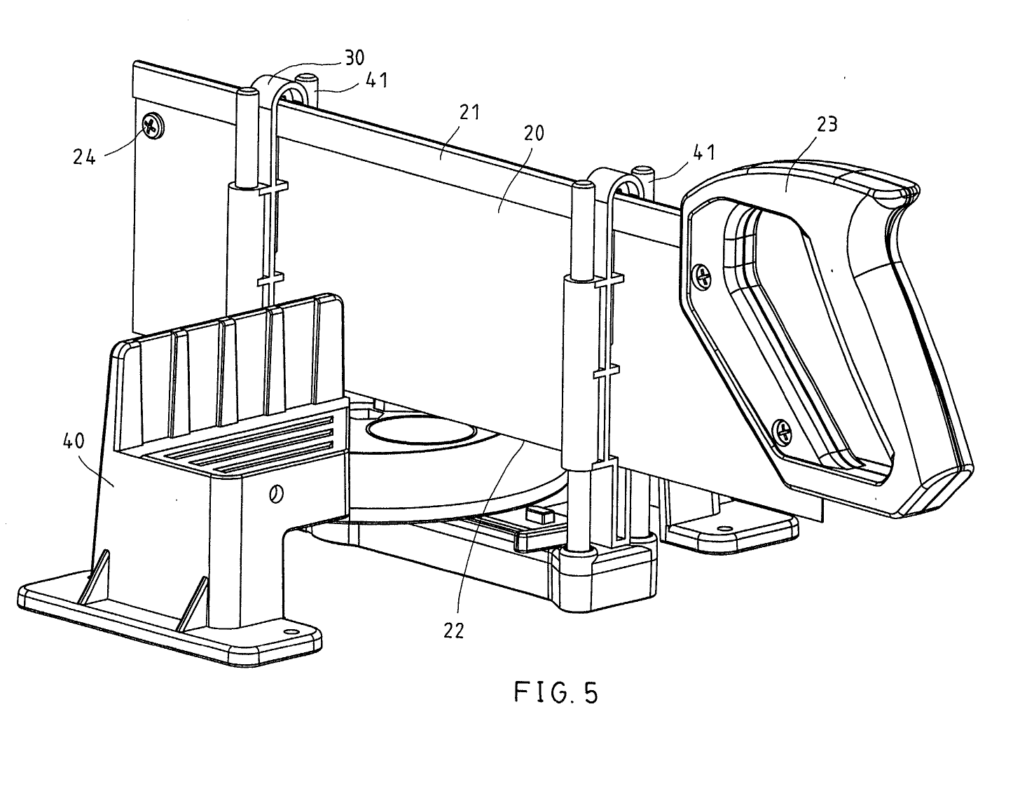

As shown in FIGS. 5 and 6, the two guiding fitting holes 35 of the guiding member 30 are fitted with the corresponding support rods 41 of the adjustable saw table. The long sawing blade 20 is then put into the narrow slit of the guiding member such that the protective plate 21 which is located on the upper end edge of the long sawing blade for holding said long sawing blade can be put into the guiding through hole 31 of the body. The bottom edge of the protective plate 21 urges the shoulder faces 33 of the guiding through hole. The body of the long sawing blade is disposed in the narrow slit 32, so as to enable the two guiding members 30 to suspend the long sawing blade between two pairs of support rods 41 of the carpenter's saw table such that the long sawing blade can move back and forth between the two guiding members. The long sawing blade is thus directly used on the adjustable saw table, without cooperating with a special hacksaw. This is very convenient to the American users.

In addition, the long sawing blade can not be easily slipped out after being mounted on the guiding members. As a result, the front end of the saw blade may be additionally provided with a bolt 24, as shown in FIG. 5, as a stopper.

What is claimed is:

1. A guiding member of a carpenter's saw table for use in mounting a long sawing blade on a pair of support rods of the saw table, the long sawing blade having a long sawing blade body which is provided in one long side with teeth, in other long side with a protective plate for holding the sawing blade body to prevent the sawing blade body from bending or deforming, said long sawing blade provided at one end with a hand grip, said guiding member of said carpenter's saw table comprising:
a long body provided at on end with a long guiding through hole and a long narrow slit extending along the longitudinal direction of said body, said slit communicated at one end thereof with said through hole and provided at the other end with a saw teeth receiving portion having a wider gap, said body being provided in two long sides with a guiding fitting hole extending along the longitudinal direction of said body for fitting said guiding member with a pair of support rods of the saw table.

2. The guiding member as defined in claim 1, wherein said guiding member and said two guiding fitting holes are made integrally.
